(19) United States
(12) Patent Application Publication
(10) Pub. No.: US 2024/0259139 A1
(43) Pub. Date: Aug. 1, 2024

(54) METHOD AND DEVICE FOR DETERMINING DOWNLINK ASSIGNMENT INDICATOR, METHOD AND DEVICE FOR CONFIGURING DOWNLINK ASSIGNMENT INDICATOR, STORAGE MEDIUM, TERMINAL, AND BASE STATION

(71) Applicant: SPREADTRUM COMMUNICATIONS (SHANGHAI) CO., LTD., Shanghai (CN)

(72) Inventor: Xingya SHEN, Shanghai (CN)

(21) Appl. No.: 18/017,771

(22) PCT Filed: Jul. 29, 2021
(86) PCT No.: PCT/CN2021/109112

§ 371 Date: Jan. 24, 2023

(30) Foreign Application Priority Data
Jul. 31, 2020 (CN) 202010759795.X

(51) Int. Cl. H04L 1/1812; H04W 72/232

(52) U.S. Cl. CPC H04L 1/1812; H04W 72/232

(57) ABSTRACT

A method and device for determining a downlink assignment indicator, a method and device for configuring a downlink assignment indicator, a storage medium, a terminal, and a base station are provided. The method for determining the downlink assignment indicator includes: receiving DCI which includes C-DAI field indication information, wherein the C-DAI field indication information indicates a cumulative number of PDSCHs scheduled by a PDCCH up to a current serving cell and a current PDCCH monitoring occasion; and determining a HARQ codebook based on the DCI.

### CROSS-REFERENCE TO RELATED APPLICATIONS

This is the U.S. national stage of application No. PCT/CN2021/109112, filed on Jul. 29, 2021. Priority under 35 U.S.C. § 119(a) and 35 U.S.C. § 365(b) is claimed to Chinese Patent Application No. 202010759795.X, filed on Jul. 31, 2020, the disclosure of which is also incorporated herein by reference

### TECHNICAL FIELD

The present disclosure generally relates to communication technology field, and more particularly, to a method and device for determining a downlink assignment indicator, a method and device for configuring a downlink assignment indicator, a storage medium, a terminal, and a base station.

### BACKGROUND

In a 5G New Radio (NR) system, Hybrid Automatic Repeat reQuest Acknowledgment (HARQ-ACK) may be adopted to feed back to a transmitter. In HARQ-ACK technology, a receiver usually checks whether a received data packet is correct. If there is no error, the receiver may transmit an ACK to the transmitter. After receiving the ACK, the transmitter may continue to transmit a next data packet. If there is an error, the receiver may transmit a Negative Acknowledgment (NACK) to the transmitter, and the transmitter may retransmit the same data packet after receiving the NACK. However, when performing HARQ-ACK feedback to the transmitter, it often occurs that multiple consecutive Downlink Control Information (DCI) are missed for detection, which leads to a feedback error during HARQ-ACK feedback.

In the current NR system, a base station can use Downlink Assignment Indicator (DAI) to indicate to a User Equipment (UE) a number of Physical Downlink Shared Channels (PDSCHs) transmitted by the base station at a current Physical Downlink Control Channel (PDCCH) monitoring occasion. Afterward, the UE determines the number of PDSCHs scheduled by the base station according to the DAI and generates a corresponding HARQ codebook to report to the base station. Specifically, the HARQ codebook includes ACK/NACK information for each PDSCH.

The DAI is divided into Counter DAI (C-DAI) and Total DAI (T-DAI). The C-DAI indicates a cumulative number of {serving cell, PDCCH monitoring occasion} groups up to a current serving cell and a current PDCCH monitoring occasion. The T-DAI indicates a total number of {serving cell, PDCCH monitoring occasion} groups until the current PDCCH monitoring occasion.

### SUMMARY

Embodiments of the present disclosure provide a method and device for determining a downlink assignment indicator, a method and device for configuring a downlink assignment indicator, a storage medium, a terminal, and a base station, which enables a UE to discover a number of missed detections of PDSCH in time and improves accuracy of HARQ codebooks.

In an embodiment of the present disclosure, a method for determining a downlink assignment indicator is provided, including receiving DCI which includes C-DAI field indication information, wherein the C-DAI field indication information indicates a cumulative number of PDSCHs scheduled by a PDCCH up to a current serving cell and a current PDCCH monitoring occasion; and determining a HARQ codebook based on the DCI.

In an embodiment of the present disclosure, a storage medium having computer instructions stored therein is provided, wherein when the computer instructions are executed, the above method for determining the downlink assignment indicator or the above method for configuring the downlink assignment indicator is performed.

In an embodiment of the present disclosure, a terminal including a memory and a processor is provided, wherein the memory has computer instructions stored therein, and when the processor executes the computer instructions, the above method for determining the downlink assignment indicator is performed.

### BRIEF DESCRIPTION OF THE DRAWINGS

FIG. 1 is a flow chart of a method for determining a downlink assignment indicator according to an embodiment.

FIG. 2 is a diagram of C-DAI field indication information and T-DAI field indication information according to an embodiment.

FIG. 3 is a diagram of C-DAI field indication information and T-DAI field indication information according to an embodiment.

FIG. 4 is a flow chart of a method for configuring a downlink assignment indicator according to an embodiment.

FIG. 5 is a structural diagram of a device for determining a downlink assignment indicator according to an embodiment.

FIG. 6 is a structural diagram of a device for configuring a downlink assignment indicator according to an embodiment.

### DETAILED DESCRIPTION

As described in the background, in the current NR system, a base station can use DAI to indicate to a UE a number of PDSCHs transmitted by the base station at a current PDCCH monitoring occasion. Afterward, the UE determines the number of PDSCHs scheduled by the base station according to the DAI and generates a corresponding HARQ codebook to report to the base station. However, the above solution is merely applicable to a case where single DCI schedules a single PDSCH. When single DCI schedules multiple PDSCHs, it is difficult for the UE to correctly determine a size of the HARQ codebook according to the received DAI, and thus cannot report a correct HARQ codebook.

Inventors of this invention found through research that in exiting techniques, a UE can directly determine a number of PDCCHs according to a PDCCH monitoring occasion in DAI. If single DCI schedules a single PDSCH, a number of PDSCHs and the number of PDCCHs are equal, and the UE can determine missed detection of PDCCH when a hop occurs in the number of PDCCHs, determine the number of missed PDCCHs according to the number of hops of PDCCHs, and then report a HARQ codebook according to a correct codebook size. However, if single DCI schedules multiple PDSCHs, the number of PDSCHs is greater than the number of PDCCHs. Even if the UE determines a missed detection of PDCCH when a hop occurs in the number of PDCCHs and determines the number of hops of PDCCHs, the number of missed detections of PDSCHs cannot be determined, resulting in inability to determine the correct codebook size when reporting the HARQ codebook.

In embodiments of the present disclosure, by configuring that C-DAI field indication information indicates a cumulative number of PDSCHs scheduled by a PDCCH up to a current serving cell and a current PDCCH monitoring occasion, a UE receiving DCI may determine a total number of PDSCHs that should be received based on the C-DAI field indication information in the DCI, which is conducive to discovering a number of missed detections of PDSCH in time, and improves accuracy of HARQ codebooks.

In order to clarify the objects, characteristics and advantages of the disclosure, embodiments of present disclosure will be described in detail in conjunction with accompanying drawings.

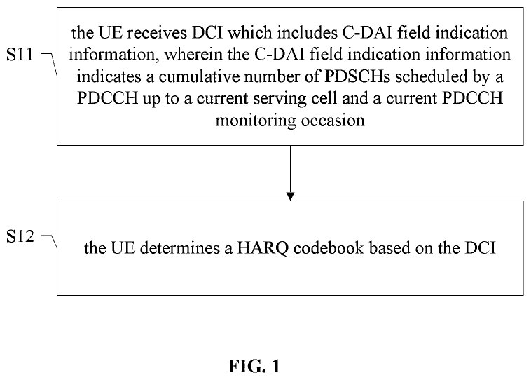

Referring to FIG. 1, FIG. 1 is a flow chart of a method for determining a downlink assignment indicator according to an embodiment. The method may be applied to a UE and includes S11 and S12.

In S11, the UE receives DCI which includes C-DAI field indication information, wherein the C-DAI field indication information indicates a cumulative number of PDSCHs scheduled by a PDCCH up to a current serving cell and a current PDCCH monitoring occasion. In S12, the UE determines a HARQ codebook based on the DCI.

In some embodiments, the method may be implemented in a manner of software programs which are run on a processor integrated within a chip or a chip module.

In some embodiments, in S11, a base station may indicate the cumulative number of PDSCHs scheduled by the PDCCH up to the current serving cell and the current PDCCH monitoring occasion through one or more C-DAI field indication information in the DCI.

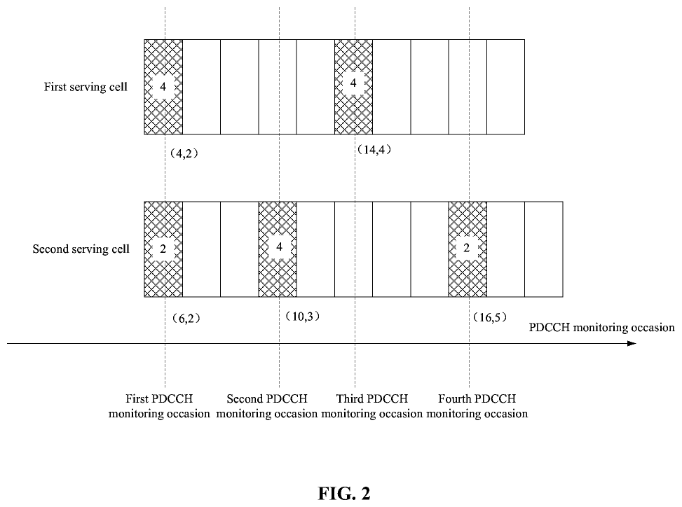

FIG. 2 is a diagram of C-DAI field indication information and T-DAI field indication information according to an embodiment.

The embodiment as shown in FIG. 2 is applicable to two serving cells (Serving Cells), and the PDCCH schedules multiple PDSCHs at multiple PDCCH monitoring occasions.

Numbers marked in boxes (such as the number 4 or 2) are the numbers of PDSCHs scheduled by the PDCCH in the corresponding serving cell, and two numbers in brackets (such as (4, 1) or (6, 2)) are the C-DAI field indication information and T-DAI field indication information, namely (C-DAI field indication information and T-DAI field indication information).

Specifically, at a first PDCCH monitoring occasion, the PDCCH schedules 4 PDSCHs in the first serving cell, and the C-DAI field indication information indicates the total number of PDSCHs scheduled by the PDCCH, which is 4. At the same time, the PDCCH schedules two PDSCHs in the second serving cell, and the C-DAI field indication information indicates the total number of PDSCHs scheduled by the PDCCH, which is (4+2-6).

In some embodiments, if the UE fails to receive the PDCCH at the first PDCCH monitoring occasion of the first serving cell, after receiving all two PDSCHs of the second serving cell, the UE may discover that (6−2=4) PDSCHs were missed according to the C-DAI field indication information of 6 in time.

It could be understood that the T-DAI field indication information follows a representation method in the existing techniques, that is, as there are two {serving cell, PDCCH monitoring occasion} groups until the current PDCCH monitoring occasion, the T-DAI field indication information is 2.

It should be noted that if the C-TAI field indication information follows a representation method in the existing techniques, that is, the C-DAI field indication information indicates a cumulative number of {serving cell, PDCCH monitoring occasion} groups up to a current serving cell and a current PDCCH monitoring occasion, the cumulative numbers are 1 and 1 respectively, that is, no matter for the first serving cell or the second serving cell, (C-DAI field indication information, T-DAI field indication information) are both (1, 2).

From above, in the existing techniques, if the UE fails to completely receive all 4 PDSCHs in the first serving cell, for example, merely 3 PDSCHs are received, the UE cannot discover in time a missed detection of the PDSCH based on the C-DAI field indication information of 1 and the T-DAI field indication information of 2. The embodiments of the present disclosure may overcome deficiencies in the existing techniques.

Further, at the second PDCCH monitoring occasion, the PDCCH schedules 4 PDSCHs in the second serving cell, and the C-DAI field indication information indicates the total number of PDSCHs scheduled by the PDCCH, which is (6+4=10). At the third PDCCH monitoring occasion, the PDCCH schedules 4 PDSCHs in the first serving cell, and the C-DAI field indication information indicates the total number of PDSCHs scheduled by the PDCCH, which is (10+4=14). At the fourth PDCCH monitoring occasion, the PDCCH schedules 2 PDSCHs in the second serving cell, and the C-DAI field indication information indicates the total number of PDSCHs scheduled by the PDCCH, which is (14+2=16).

Still referring to FIG. 1, in some embodiments, in S12, the UE determines the HARQ codebook based on the DCI.

Further, the UE determines the HARQ codebook based on the C-DAI field indication information.

In embodiments of the present disclosure, by configuring that C-DAI field indication information indicates a cumulative number of PDSCHs scheduled by a PDCCH up to a current serving cell and a current PDCCH monitoring occasion, a UE receiving DCI may determine a total number of PDSCHs that should be received based on the C-DAI field indication information in the DCI, which is conducive to discovering a number of missed detections of PDSCH in time, and improves accuracy of HARQ codebooks.

In some embodiments, said determining the HARQ codebook based on the C-DAI field indication information includes determining a number of ACK/NACK information contained in the HARQ codebook based on the cumulative number of the PDSCHs indicated by the C-DAI field indication information, wherein each ACK/NACK information is in one-to-one correspondence with one of the PDSCHs.

In some embodiments, the C-DAI field indication information is carried in a last detected PDCCH which is the last PDCCH indicating a PUCCH or PUSCH carrying the HARQ codebook.

Taking the embodiment shown in FIG. 2 as an example, when 16 PDSCHs are received at the fourth PDCCH monitoring occasion, the UE can determine that a size of the reported HARQ codebook is 16, that is, including 16 pieces of ACK/NACK information. For example, a missed detection of PDCCH occurs at the third monitoring occasion on the first serving cell. The UE determines that the number of PDSCHs missed at the third PDCCH monitoring occasion is (16-10-2-4) based on the number of PDSCHs at the second PDCCH monitoring occasion being 10, the number of PDSCHs at the fourth PDCCH monitoring occasion being 2, and the total number being 16.

Further, when reporting the HARQ codebook, the UE may mark all four PDSCHs missed at the third PDCCH monitoring occasion as missed detection.

Further, for the missed PDSCHs, the ACK/NACK information may include NACK and/or 1-bit missed detection indication information.

Specifically, taking the missed detection of 4 PDSCHs at the third PDCCH monitoring occasion as an example. If the ACK/NACK information is 1-bit missed detection indication information, the HARQ codebook reported by the UE may be (1, 1, 1, 1, 1, 1, 1, 1, 1, 1, 0, 0, 0, 0, 1, 1), where the first ten Is indicate that there is no missed detection from the first PDCCH monitoring occasion to the second PDCCH monitoring occasion, the middle four 0s indicate that 4 PDSCHs are missed at the third PDCCH monitoring occasion, and the last two 1s indicate that there is no missed detection is at the fourth PDCCH monitoring occasion.

It could be understood that if ACK/NACK information is NACK for the missed PDSCH, “1” in the 1-bit missed detection indication information may be replaced with ACK, and “0” therein may be replaced with NACK.

In the embodiments of the present disclosure, the cumulative number of the PDSCHs indicated by the C-DAI field indication information may serve as the number of ACK/NACK information contained in the HARQ codebook, and each ACK/NACK information is in one-to-one correspondence with one of the PDSCHs, so that the UE may explicitly mark the missed PDSCHs in the reported HARQ codebook to improve effectiveness and accuracy of feedback.

In some embodiments, the DCI may further include T-DAI field indication information which indicates a total number of PDSCHs scheduled by the PDCCH until the current PDCCH monitoring occasion; and said determining a HARQ codebook based on the DCI includes determining the HARQ codebook based on the T-DAI field indication information.

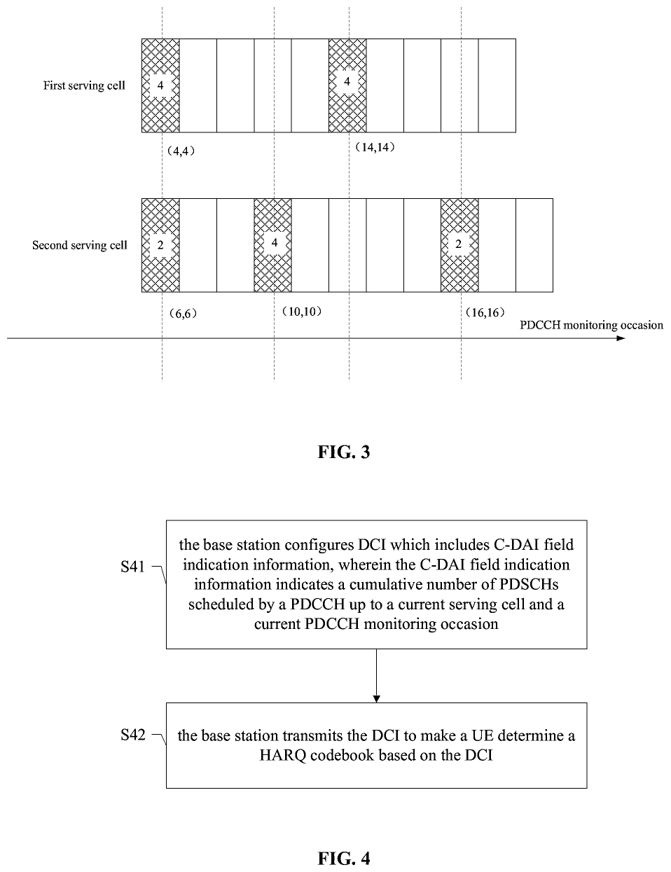

FIG. 3 is a diagram of C-DAI field indication information and T-DAI field indication information according to another embodiment.

The embodiment as shown in FIG. 3 is also applicable to two serving cells (Serving Cells), and the PDCCH schedules multiple PDSCHs at multiple PDCCH monitoring occasions.

Numbers marked in boxes (such as the number 4 or 2) are the numbers of PDSCHs scheduled by the PDCCH in the corresponding serving cell, and two numbers in brackets (such as (4, 4) or (6, 6)) are the C-DAI field indication information and T-DAI field indication information, namely (C-DAI field indication information and T-DAI field indication information).

It should be noted that the representation of the C-DAI field indication information as shown in FIG. 3 is the same as that in FIG. 2 and is not repeated here. In FIG. 3, the T-DAI field indication information and the C-DAI field indication information represent the same meaning, which indicates the total number of PDSCHs scheduled by the PDCCH at the current PDCCH monitoring occasion.

In the embodiments of the present disclosure, the DCI also includes the T-DAI field indication information. As algorithms/formulas involved in HARQ codebooks in existing techniques are usually implemented based on T-DAI field indication information, the UE may, after receiving the DCI, determine a total number of PDSCHs that should be received until the current PDCCH monitoring occasion based on the T-DAI field indication information in the DCI, which is conducive to timely discovery of a number of missed detections of PDSCH, and improves adaptability to solutions in the existing techniques.

Further, the C-DAI field indication information and the T-DAI field indication information are represented by consecutive character strings, and a character string representing the C-DAI field indication information is located in front of a character string representing the T-DAI field indication information.

In some embodiments, the base station may configure the DCI in a manner of (C-DAI field indication information, T-DAI field indication information). (C-DAI field indication information, T-DAI field indication information) adopts N-bit character strings, where the C-DAI field indication information uses the first N1-bit character string, the T-DAI field indication information uses the following N2-bit character string, N1 and N2 are both natural numbers, and N1+N2=N.

In the embodiments of the present disclosure, the C-DAI field indication information and the T-DAI field indication information are represented by consecutive character strings, and a character string representing the C-DAI field indication information is located in front of a character string representing the T-DAI field indication information, which may enable the UE to more accurately determine contents of the C-DAI field indication information and the T-DAI field indication information.

FIG. 4 is a flow chart of a method for configuring a downlink assignment indicator according to an embodiment. The method may be applied to a base station and includes S41 and S42.

In S41, the base station configures DCI which includes C-DAI field indication information, wherein the C-DAI field indication information indicates a cumulative number of PDSCHs scheduled by a PDCCH up to a current serving cell and a current PDCCH monitoring occasion.

In S42, the base station transmits the DCI to make a UE determine a HARQ codebook based on the DCI.

In some embodiments, the DCI further includes T-DAI field indication information which indicates a total number of PDSCHs scheduled by the PDCCH until the current PDCCH monitoring occasion; and said transmitting the DCI to make a UE determine a HARQ codebook based on the DCI includes transmitting the DCI to make the UE determine the HARQ codebook based on the T-DAI field indication information.

In some embodiments, the C-DAI field indication information and the T-DAI field indication information are represented by consecutive character strings.

More details of S41 and S42 can be referred to related descriptions of S11 and S12 as shown in FIG. 1, and are not repeated here.

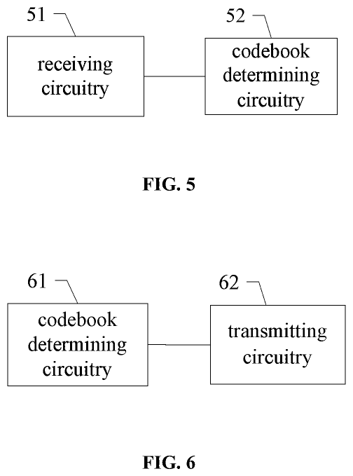

Referring to FIG. 5, FIG. 5 is a structural diagram of a device for determining a downlink assignment indicator according to an embodiment. The apparatus may be applied to a UE and includes a receiving circuitry 51 configured to receive DCI which includes C-DAI field indication information, wherein the C-DAI field indication information indicates a cumulative number of PDSCHs scheduled by a PDCCH up to a current serving cell and a current PDCCH monitoring occasion; and a codebook determining circuitry 52 configured to determine a HARQ codebook based on the DCI.

In some embodiments, the apparatus may correspond to a chip with a data processing function in a UE, or to a chip module including a chip with a data processing function in the UE, or to the UE.

Principles, specific implementation manners and advantages of the device for determining the downlink assignment indicator can be referred to related descriptions of the method for determining the downlink assignment indicator and are not repeated here.

Referring to FIG. 6, FIG. 6 is a structural diagram of a device for configuring a downlink assignment indicator according to an embodiment. The apparatus may be applied to a base station and includes a codebook determining circuitry 61 configured to configure DCI which includes C-DAI field indication information, wherein the C-DAI field indication information indicates a cumulative number of PDSCHs scheduled by a PDCCH up to a current serving cell and a current PDCCH monitoring occasion; and a transmitting circuitry 62 configured to transmit the DCI to make a UE determine a HARQ codebook based on the DCI.

Principles, specific implementation manners and advantages of the device for configuring the downlink assignment indicator can be referred to related descriptions of the method for configuring the downlink assignment indicator and are not repeated here.

In an embodiment of the present disclosure, a storage medium having computer instructions stored therein is provided, wherein when the computer instructions are executed, the above method is performed. In some embodiments, the storage medium may be a computer readable storage medium and may include a non-volatile or a non-transitory memory, or include an optical disk, a magnetic disk or a solid disk.

In the embodiments of the present disclosure, the processor may be a Central Processing Unit (CPU), or other general processors, Digital Signal Processors (DSPs), Application Specific Integrated Circuits (ASICs), Field Programmable Gate Arrays (FPGAs) or other Programmable logic devices, discrete gates or transistor logic devices, discrete hardware components, and the like. A general processor may be a microprocessor, or the processor may be any conventional processor or the like.

It should also be understood that the memory in the embodiments of the present disclosure may be either volatile memory or nonvolatile memory or may include both volatile and nonvolatile memories. The non-volatile memory may be a Read-Only Memory (ROM), a Programmable ROM (PROM), an Erasable PROM (EPROM), an electrically Erasable EPROM (EEPROM), or a flash memory. The volatile memory may be a Random Access Memory (RAM) which functions as an external cache. By way of example but not limitation, various forms of RAM are available, such as Static Random Access Memory (SRAM), Dynamic Random Access Memory (DRAM), Synchronous Dynamic Random Access Memory (SDRAM), Double Data Rate Synchronous Dynamic Random Access Memory (DDR SDRAM), Enhanced SDRAM (ESDRAM), Synchronous connection to DRAM (SLDRAM), and Direct Rambus RAM (DR-RAM).

In an embodiment of the present disclosure, a terminal including a memory and a processor is provided, wherein the memory has computer instructions stored therein, and when the processor executes the computer instructions, the above method is performed. The terminal may include but not limited to a mobile phone, a computer or a tablet computer.

The terminal in the embodiments of the present disclosure may refer to various forms of UE, access terminal, user unit, user station, Mobile Station (MS), remote station, remote terminal, mobile equipment, user terminal, terminal equipment, wireless communication equipment, user agent or user device. The terminal equipment may further be a cellular phone, a cordless phone, a Session Initiation Protocol (SIP) phone, a Wireless Local Loop (WLL) station, a Personal Digital Assistant (PDA), a handheld device with a wireless communication function, a computing device or other processing devices connected to a wireless modems, an in-vehicle device, a wearable device, a terminal equipment in the future 5G network, or a terminal equipment in a future evolved Public Land Mobile Network (PLMN), which is not limited in the embodiments of the present disclosure.

In an embodiment of the present disclosure, a base station including a memory and a processor is provided, wherein the memory has computer instructions stored therein, and when the processor executes the computer instructions, the above method is performed.

The Base Station (BS) in the embodiments of the present disclosure may also be referred to as a base station equipment, and is a device deployed in a Radio Access Network (RAN) to provide radio communication functions. For example, an equipment that provides a base station function in a 2G network includes a Base Transceiver Station (BTS). An equipment that provides the base station function in a 3G network includes a Node B. An equipment that provides the base station function in a 4G network includes an evolved node B (eNB). In a Wireless Local Area Network (WLAN), an equipment that provides the base station function is an Access Point (AP). An equipment that provides the base station function in a 5G New Radio (NR) includes gNB and a continuously evolved Node B (ng-eNB), where gNB and the terminal use NR technology for communication, ng-eNB and the terminal use Evolved Universal Terrestrial Radio Access (E-UTRA) technology for communication, and both gNB and ng-eNB can be connected to a 5G core network. And the base station also refers to an equipment that provides the base station function in a new communication system in the future.

A base station controller in the embodiments of the present disclosure refers to an apparatus in charge of the base station, such as a Base Station Controller (BSC) in a 2G network, a Radio Network Controller (RNC) in a 3G network, or any apparatus that controls and manages the base station in new communication systems in the future.

The network in the embodiments of the present disclosure refers to a communication network that provides communication services for terminals, including a base station of a radio access network, a base station controller of a radio access network, and a device on a core network side.

Each module/unit of each apparatus and product described in the above embodiments may be a software module/unit or a hardware module/unit or may be a software module/unit in part, and a hardware module/unit in part. For example, for each apparatus or product applied to or integrated in a chip, each module/unit included therein may be implemented by hardware such as circuits; or, at least some modules/units may be implemented by a software program running on a processor integrated inside the chip, and the remaining (if any) part of the modules/units may be implemented by hardware such as circuits. For each apparatus or product applied to or integrated in a chip module, each module/unit included therein may be implemented by hardware such as circuits. Different modules/units may be disposed in a same component (such as a chip or a circuit module) or in different components of the chip module. Or at least some modules/units may be implemented by a software program running on a processor integrated inside the chip module, and the remaining (if any) part of the modules/units may be implemented by hardware such as circuits. For each apparatus or product applied to or integrated in a terminal, each module/unit included therein may be implemented by hardware such as circuits. Different modules/units may be disposed in a same component (such as a chip or a circuit module) or in different components of the terminal. Or at least some modules/units may be implemented by a software program running on a processor integrated inside the terminal, and the remaining (if any) part of the modules/units may be implemented by hardware such as circuits.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

What is claimed is:

1. A method for determining a downlink assignment indicator, comprising:
receiving Downlink Control Information (DCI) which comprises Counter-Downlink Assignment Indicator (C-DAI) field indication information, wherein the C-DAI field indication information indicates a cumulative number of Physical Downlink Shared Channels (PDSCHs) scheduled by a Physical Downlink Control Channel (PDCCH) up to a current serving cell and a current PDCCH monitoring occasion; and
determining a Hybrid Automatic Repeat reQuest (HARQ) codebook based on the DCI.

2. The method according to claim 1, wherein said determining a HARQ codebook based on the DCI comprises:
determining the HARQ codebook based on the C-DAI field indication information.

3. The method according to claim 2, wherein said determining the HARQ codebook based on the C-DAI field indication information comprises:
determining a number of Acknowledgment/Negative Acknowledgment (ACK/NACK) information contained in the HARQ codebook based on the cumulative number of the PDSCHs indicated by the C-DAI field indication information, wherein each ACK/NACK information is in one-to-one correspondence with one of the PDSCHs.

4. The method according to claim 3, wherein for a missed PDSCH, the ACK/NACK information comprises NACK and/or 1-bit missed detection indication information.

5. The method according to claim 1, wherein the DCI further comprises Total-Downlink Assignment Indicator (T-DAI) field indication information which indicates a total number of PDSCHs scheduled by the PDCCH until the current PDCCH monitoring occasion; and
said determining a HARQ codebook based on the DCI comprises: determining the HARQ codebook based on the T-DAI field indication information.

6. The method according to claim 5, wherein the C-DAI field indication information and the T-DAI field indication information are represented by consecutive character strings, and a character string representing the C-DAI field indication information is located in front of a character string representing the T-DAI field indication information.

7. (canceled)

8. (canceled)

9. (canceled)

10. (canceled)

11. (canceled)

12. A non-transitory storage medium storing one or more programs, the one or more programs comprising computer instructions, which, when executed by a processor, cause the processor to:
receive Downlink Control Information (DCI) which comprises Counter-Downlink Assignment Indicator (C-DAI) field indication information, wherein the C-DAI field indication information indicates a cumulative number of Physical Downlink Shared Channels (PDSCHs) scheduled by a Physical Downlink Control Channel (PDCCH) up to a current serving cell and a current PDCCH monitoring occasion; and
determine a Hybrid Automatic Repeat reQuest (HARQ) codebook based on the DCI.

13. A terminal comprising a memory and a processor, stores one or more programs, the one or more programs comprising computer instructions, which, when executed by the processor, cause the processor to:
receive Downlink Control Information (DCI) which comprises Counter-Downlink Assignment Indicator (C-DAI) field indication information, wherein the C-DAI field indication information indicates a cumulative number of Physical Downlink Shared Channels (PDSCHs) scheduled by a Physical Downlink Control Channel (PDCCH) up to a current serving cell and a current PDCCH monitoring occasion; and
determine a Hybrid Automatic Repeat reQuest (HARQ) codebook based on the DCI.

14. (canceled)

15. The non-transitory storage medium according to claim 12, wherein the processor is further caused to:
determine the HARQ codebook based on the C-DAI field indication information.

16. The non-transitory storage medium according to claim 15, wherein the processor is further caused to:
determine a number of Acknowledgment/Negative Acknowledgment (ACK/NACK) information contained in the HARQ codebook based on the cumulative number of the PDSCHs indicated by the C-DAI field indication information, wherein each ACK/NACK information is in one-to-one correspondence with one of the PDSCHs.

17. The non-transitory storage medium according to claim 16, wherein for a missed PDSCH, the ACK/NACK information comprises NACK and/or 1-bit missed detection indication information.

18. The non-transitory storage medium according to claim 12, wherein the DCI further comprises Total-Downlink Assignment Indicator (T-DAI) field indication information which indicates a total number of PDSCHs scheduled by the PDCCH until the current PDCCH monitoring occasion; and
the processor is further caused to: determine the HARQ codebook based on the T-DAI field indication information.

19. The non-transitory storage medium according to claim 18, wherein the C-DAI field indication information and the T-DAI field indication information are represented by consecutive character strings, and a character string representing the C-DAI field indication information is located in front of a character string representing the T-DAI field indication information.

20. The terminal according to claim 13, wherein the processor is further caused to:
determine the HARQ codebook based on the C-DAI field indication information.

21. The terminal according to claim 20, wherein the processor is further caused to:
determine a number of Acknowledgment/Negative Acknowledgment (ACK/NACK) information contained in the HARQ codebook based on the cumulative number of the PDSCHs indicated by the C-DAI field indication information, wherein each ACK/NACK information is in one-to-one correspondence with one of the PDSCHs.

22. The terminal according to claim 21, wherein for a missed PDSCH, the ACK/NACK information comprises NACK and/or 1-bit missed detection indication information.

23. The terminal according to claim 13, wherein the DCI further comprises Total-Downlink Assignment Indicator (T-DAI) field indication information which indicates a total number of PDSCHs scheduled by the PDCCH until the current PDCCH monitoring occasion; and
the processor is further caused to: determine the HARQ codebook based on the T-DAI field indication information.

24. The terminal according to claim 23, wherein the C-DAI field indication information and the T-DAI field indication information are represented by consecutive character strings, and a character string representing the C-DAI field indication information is located in front of a character string representing the T-DAI field indication information.
